(19) United States
(12) Patent Application Publication
(10) Pub. No.: US 2007/0233620 A1
(43) Pub. Date: Oct. 4, 2007

(54) COMPUTER READABLE RECORDING MEDIUM HAVING DESIGN CREATION SUPPORTING PROGRAM STORED THEREON, DESIGN CREATION SUPPORTING APPARATUS AND COMPUTER DATA SIGNAL FOR SUPPORTING DESIGN CREATION

(75) Inventors: Yoshitsugu Hirose, Kanagawa (JP); Kazushi Ozawa, Tokyo (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/695,635

(22) Filed: Apr. 3, 2007

(30) Foreign Application Priority Data
Apr. 4, 2006 (JP) 2006103664

(51) Int. Cl. G06F 17/00

(52) U.S. Cl. 706/11

(57) ABSTRACT

The process cause a user to select and acquire at least one option matching an impression that is the target of the design creation of the document from plural impression expression databases, and extracts impression information associated with the option selected from the plural impression expression databases by referencing the impression evaluation database, and makes at least one item of the extracted impression information as the desired impression information that represents an impression that is a target of the design creation of the document.

### CROSS-REFERENCE TO RELATED APPLICATIONS

This application is based on, and claims priority under 35 USC 119 from, Japanese Patent Application No. 2006-103664 filed on Apr. 4, 2006.

### BACKGROUND

1. Technical Field

The present invention relates to a computer readable recording medium having stored thereon a design creation supporting program that supports design creation based on an intended impression of the design, an impression of an actually created design, and an impression a user receives from the design, a design creation supporting apparatus and a computer data signal for supporting design creation.

2. Related Art

Designs of company cooperate marks, goods, reference materials for presentation, website pages, and so on significantly affect the impression given to customers and users, and so on. Thus, in design creation, it is important to appropriately and precisely represent an impression which persons attempting to provide corporate strategies and marketing strategies or provide information wish to make on receivers (users).

When one requests design creation of a product to a design creator, for example, as shown in the flowchart in FIG. 34, a client, who is a requesting person, determines a desired impression required for the product or presentation materials of the product (S100), and the design creator produces a design matching the desired impression (S102). The impression of the produced design is then evaluated (S104), and based on a difference between the required impression and the impression of the actual design, the requesting person provides instructions for changing the design, if it is necessary, and otherwise, the design is finally determined (S106).

With regard to such design creation as described above, a large number of software applications have been developed for supporting image rendering and coloring of products or documents such as presentation materials and web pages. In most of these applications, however, actual coloring is left to application users, leading to a problem that users not skilled in design creation would have difficulty in appropriately and precisely representing a desired impression.

In order to deal with the above difficulty, studies and research have been made concerning a method for performing a process and evaluating an impression of a document based on human sensibilities.

### SUMMARY

According to an aspect of the present invention, there is provided a computer readable recording medium for causing a computer having a memory for storing plural impression expression databases including a group of options that represent an impression of a document, wherein the group of options are different, and an impression evaluation database in which impression information obtained by a person as the person views a document is associated with the options included in the plural impression expression databases.

That is to say, an impression information acquiring process for letting a user select at least one option matching an impression that is the target of the design creation of the document from each of the plural impression expression databases and acquiring it, and a desired impression information setting process for extracting impression information associated with the option selected from the plural impression expression databases by referencing the impression evaluation database and making at least one item of the extracted impression information be the desired impression information that represents an impression that is a target of the design creation of the document.

### BRIEF DESCRIPTION OF THE DRAWINGS

Exemplary embodiments of the present invention will be described in detail based on the following figures, wherein:

FIG. 1 is a block diagram of the overall configuration of a design creation supporting apparatus in an exemplary embodiment of the present invention;

FIG. 2 is a block diagram of a configuration of a management server in an exemplary embodiment of the present invention;

FIG. 3 is a diagram showing a main flowchart of a design creation supporting method in an exemplary embodiment of the present invention;

FIG. 4 is a diagram showing a main menu screen in an exemplary embodiment of the present invention;

FIG. 5 is a diagram showing a flowchart of a desired impression decision process in an exemplary embodiment of the present invention;

FIG. 6 is a diagram showing a desired impression input screen in an exemplary embodiment of the present invention;

FIG. 7A and FIG. 7B are a diagram showing an impression expression databases in an exemplary embodiment of the present invention;

FIG. 8 is a diagram showing an impression map in an exemplary embodiment of the present invention;

FIG. 9 is a diagram showing a desired impression input screen in an exemplary embodiment of the present invention;

FIG. 10 is a diagram showing a distribution on an impression map of a second impression expression database in an exemplary embodiment of the present invention;

FIG. 11A and FIG. 11B are a diagram showing an impression evaluation databases in an exemplary embodiment of the present invention;

FIG. 12 is a diagram showing a third impression expression database in an exemplary embodiment of the present invention;

FIG. 13 is a diagram showing a flowchart of a modification of a desired impression decision process in an exemplary embodiment of the present invention;

FIG. 14 is a diagram showing a desired impression input screen in an exemplary embodiment of the present invention;

FIG. 15 is a diagram showing a third impression evaluation database in an exemplary embodiment of the present invention;

FIG. 16 is a diagram showing a flowchart of a design impression evaluation process in an exemplary embodiment of the present invention;

FIG. 17 is a diagram showing a design impression evaluation screen in an exemplary embodiment of the present invention;

FIG. 18 is a diagram showing a design database in an exemplary embodiment of the present invention;

FIG. 19 is a diagram showing a web page in an exemplary embodiment of the present invention;

FIG. 20 is a diagram showing a design evaluation database in an exemplary embodiment of the present invention;

FIG. 21 is a diagram showing a flowchart of a user impression acquisition process in an exemplary embodiment of the present invention;

FIG. 22 is a diagram showing a document data selection screen in an exemplary embodiment of the present invention;

FIG. 23 is a diagram showing a user impression input screen in an exemplary embodiment of the present invention;

FIG. 24 is a diagram showing a user impression input screen in an exemplary embodiment of the present invention;

FIG. 25 is a diagram showing a user impression information database in an exemplary embodiment of the present invention;

FIG. 26 is a diagram showing a flowchart of an impression presentation/correction process in an exemplary embodiment of the present invention;

FIG. 27 is a diagram showing a display selection screen in an exemplary embodiment of the present invention;

FIG. 28 is a diagram showing an impression map screen in an exemplary embodiment of the present invention;

FIG. 29 is a diagram showing an impression map displaying database in an exemplary embodiment of the present invention;

FIG. 30 is a diagram showing an impression map screen on which the desired impression information is superimposed;

FIG. 31 is a diagram showing an impression map screen on which the design impression information and the document data are superimposed;

FIG. 32 is a diagram showing an impression map screen on which the user impression information is superimposed;

FIG. 33 is a diagram showing an impression map screen on which the desired impression information, the design impression information and the document data are superimposed; and

FIG. 34 is a diagram showing a flowchart of the design creation.

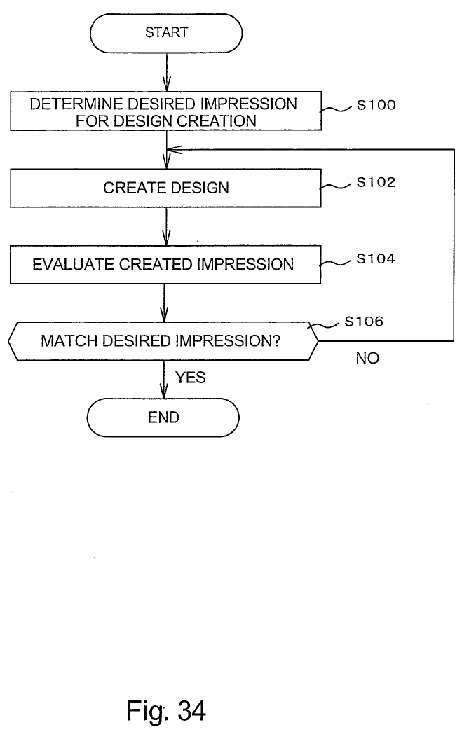

### DETAILED DESCRIPTION

### 1. Structure of Apparatus

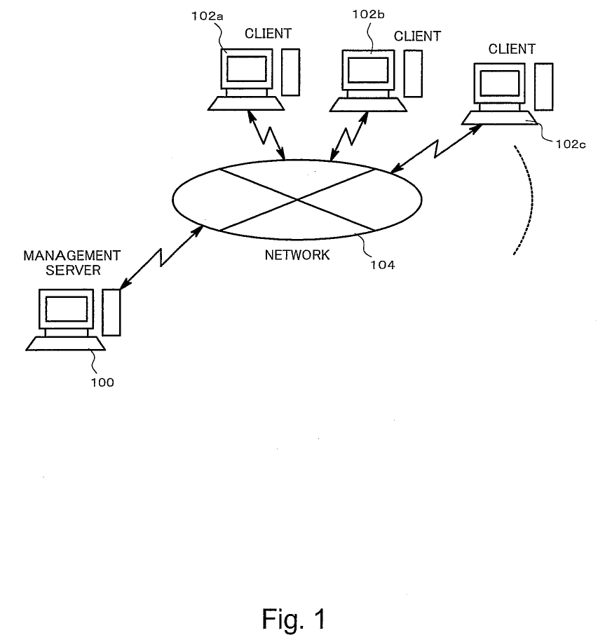

A design creation supporting apparatus in an exemplary embodiment of the present invention includes a management server 100, client computers 102a, 102b, . . . , and a network 104 as shown in FIG. 1. The management server 100 and the client computers 102a, 102b . . . are connected so as to be able to transfer information via the network 104.

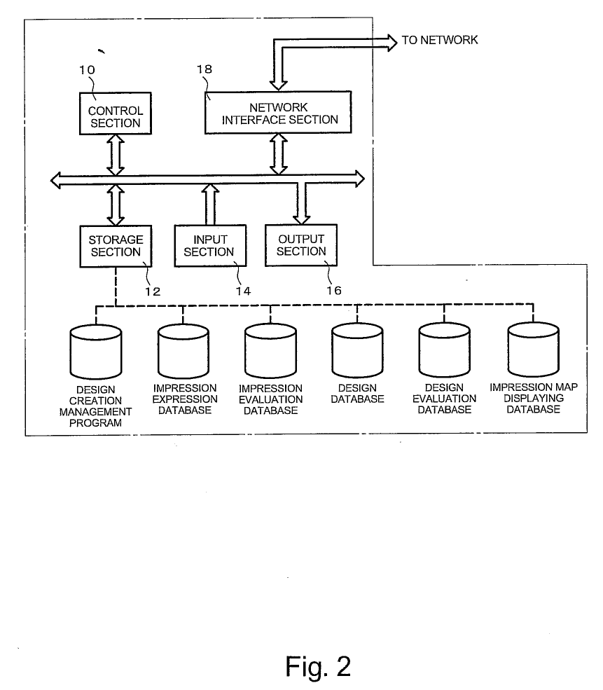

The management server 100 basically includes a control section 10, a storage section 12, an input section 14, an output section 16 and a network interface section 18 as shown in FIG. 2.

The control section 10 reads out the design creation supporting program saved in the storage section 12 and executes it. It captures data required for processing from the input section 14 and the network 104 and stores it into the storage section 12. If it is required for processing, it reads out data kept in the storage section 12 and causes the data to be processed. It further stores the processed result in the storage section 12 again and outputs to the output section 16 or the network 104 as required.

The storage section 12 stores and keeps a design creation supporting program and various types of data such as keywords and the like captured from the input section 14 or the network. It also stores and keeps databases such as an impression expression database, an impression evaluation database, a design evaluation database, a design database, an impression map displaying database and the like that are required for processing. The contents and usage of each database will be described later. As the storage section 12, a semiconductor memory is mainly used, but, for example, a storage device such as a hard disk, an optical disk, a magneto-optical disk, a magnetic tape or the like may be used.

The input section 14 is used when data required by a user for processing is input. As the input section 14, for example, a character input device such as a keyboard or a pointing device such as a mouse or a light pen can be used. When existing presentation materials or the like created on the recording medium such as a sheet of paper are read in as electronic data, a document reading device such as a scanner or the like and an audio input device for enabling conversion into a digital signal when audio is input can be used.

The output section 16 displays an input screen for prompting to input data required for processing, an output screen showing a processing result at the control section 10 and the like. As the output section 16, for example, a document output device such as a display, a printer and the like can be used.

The network interface section 18 is used for connecting the management server 100 so as to be able to communicate information with the network 104.

The client computers 102a, 102b, . . . also have a basic configuration of a computer as the management server 100 does. The client computers 102a, 102b, . . . can also send information required for processing to the management server 100 or receive the processing result in the management server 100 over the network 104. Some of the processing of the design creation supporting method shown below may be executed by the client computer 102.

### 2. Design Creation Supporting Method

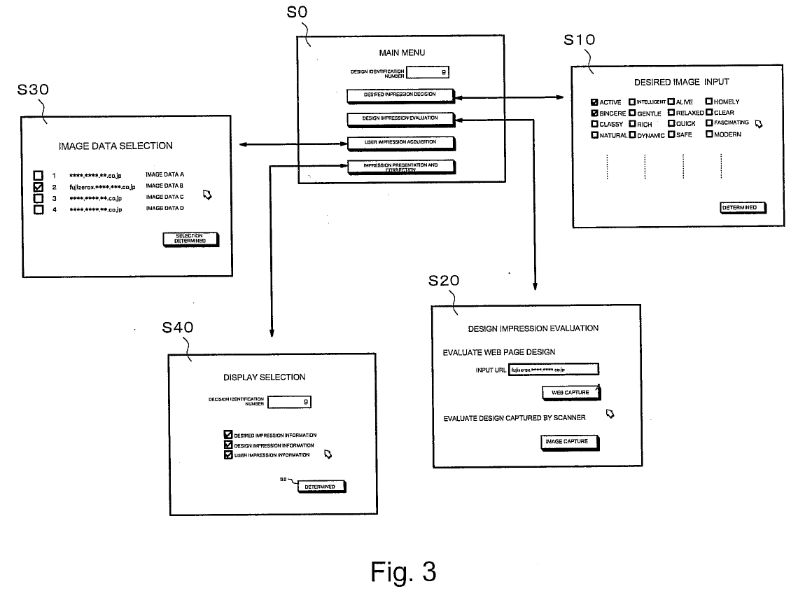

The design creation supporting method in an exemplary embodiment will be detailed below with reference to FIG. 3. Each unit in the present invention according to the claims is implemented by causing a computer to process each process of the design creation supporting method below.

Here, it is assumed that one who creates a design (hereinafter, referred to as a design creator), one who requests the design creator to create a design (hereinafter, referred to as a client), and one who receives a created design (hereinafter, referred to as a user) use the system. The operations that can be performed by any of the design creator, the client and the user are assumed to be generally performed by an operator. Usually, the design creator, the client and the user are different, but the design creator, the client and the user may be the same when the design creator appropriately corrects the design created by themselves.

The client computers 102a, 102b . . . is connected with and communicate with the management server 100 via the network 104 respectively, being able to function as a design creator's terminal or a client's terminal respectively. In the description below, the operator is assumed to perform processing by using the management server 100.

The design creation supporting method includes a desired impression decision process at the step S10, a design impression evaluation process at the step S20, a user impression acquisition process at the step S30 and an impression presentation/correction process at the step S40 as in FIG. 3.

The respective processes are implemented as design creation supporting programs that can be processed by the computer and stored and kept in the storage section 12 of the management server 100, and the management server 100 is caused to execute the programs.

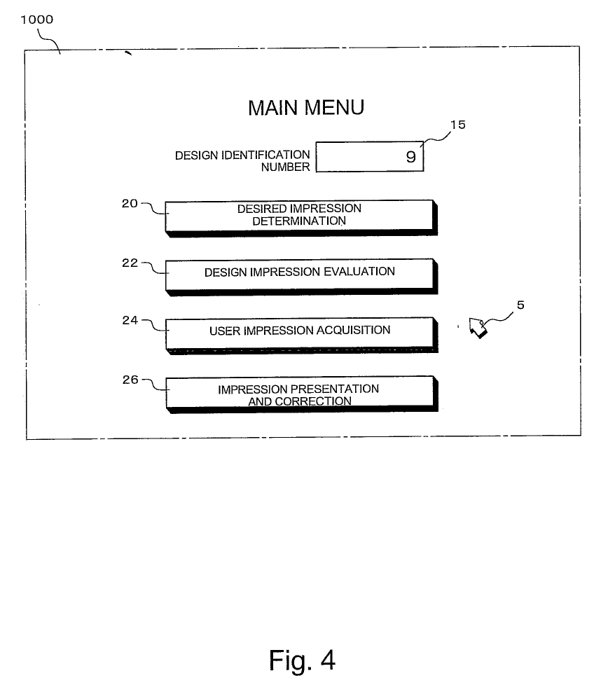

When the processing of the program starts, at the step S0, as shown in FIG. 4, the control section 10 causes the output section 16 to display a main menu screen 1000 and prompts the operator to select desired processing. Here, a mouse pointer 5 is displayed on the main menu screen 1000, and in response to clicking on a screen position showing a desired processing, execution of each processing starts.

On the main menu screen 1000, a box 15 for inputting an identification number for a design to be created is provided. A database or the like that is subjected to the processing below is identified by the number inputted in the box 15.

For example, as “9” is inputted in the box 15 as the identification number, a mouse pointer 5 is moved to a place where a desired impression decision button 20 is displayed, and the mouse is clicked on it, the identification number of the design becomes 9 and the processing proceeds to a desired impression decision process at the step S10. Similarly, when the processing is to proceed to the design impression evaluation process at the step S20, the user impression acquisition step at the step S30 and the impression presentation/correction step at the step S40, the processing can proceed as the mouse pointer 5 is moved to a place where each of a design impression evaluation button 22, a user impression acquisition button 24 and an impression presentation/correction button 26 is displayed, and the mouse is clicked on it.

### 2-1. Desired Impression Deciding Step

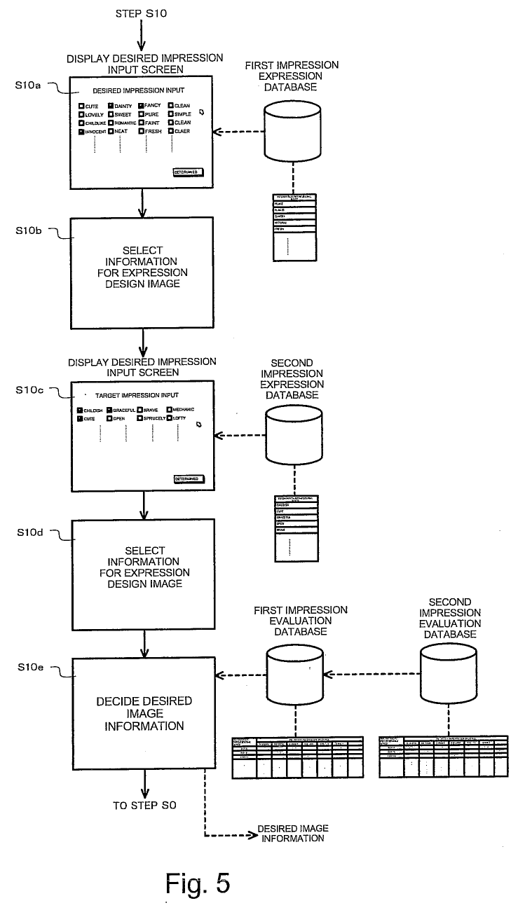

At the desired impression deciding step as the step S10, information on an impression required for a design to be created (hereinafter, referred to as desired impression information) is defined. The desired impression deciding step is processed according to the flowchart shown in FIG. 5.

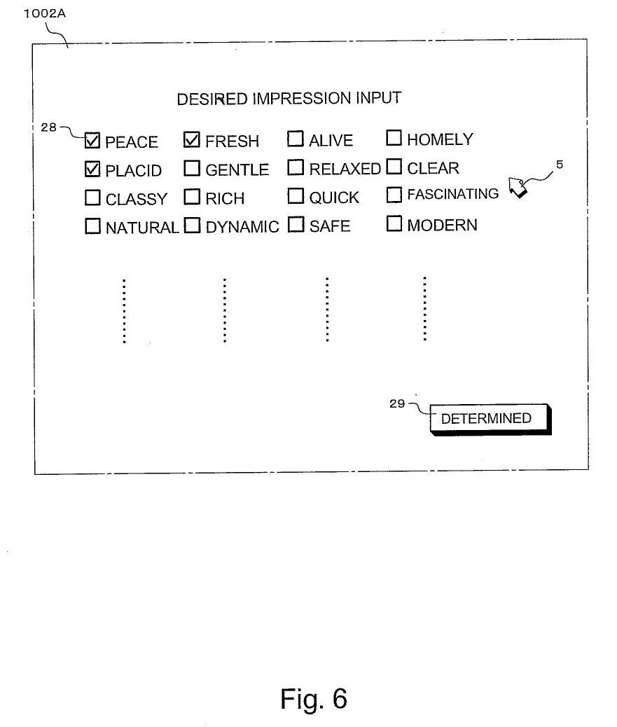

At the step S10a, the control section 10 causes the output section 16 to display the desired impression input screen 1002A. The desired impression input screen 1002A presents plural items of information representing an impression of the design as shown in FIG. 6 for a client to select information that matches a desired impression of the design creation.

Here, it is preferable to select and use character information including groups of adjectives plainly representing an impression of the design and color information including groups of color palettes of combination of colors as required according to the object of the design creation for the information representing an impression of the design. These kinds of information are previously saved in the storage section 12 as an impression expression database so that it can be used by being read as required.

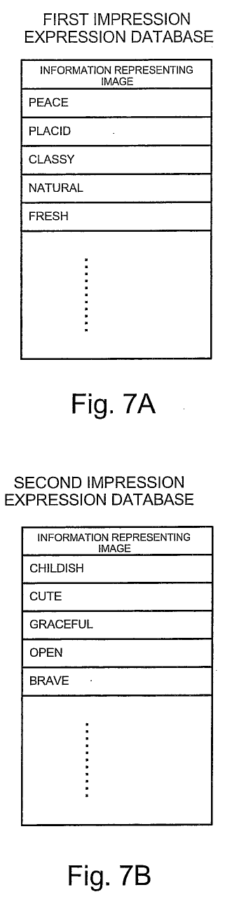

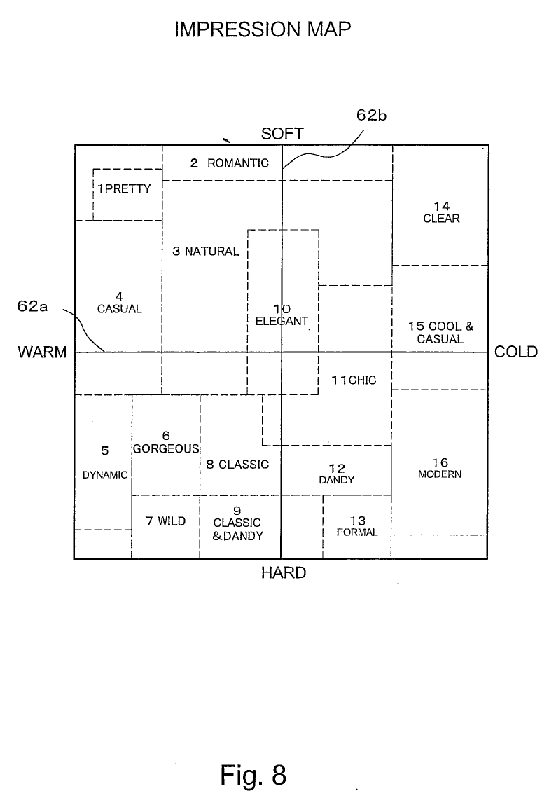

In the exemplary embodiment, first, an impression of the document is acquired from a user by using a first impression expression database of FIG. 7A. The first impression expression database includes representations of adjectives covering the whole of the impression map as shown in FIG. 8. Here, an impression map is such that the display screen is divided into plural regions and each region is allocated as a region showing an impression of a document. Each map is provided with coordinates, to which information representing an impression is allocated so that an impression changes in a predetermined tendency along the coordinates. For example, in the example in FIG. 8, two orthogonal coordinates of a X coordinate indicating warmth of the design from “warm” to “cold” and a Y coordinate indicating hardness of the design from “soft” to “hard” are provided, and information representing impressions according to change in respective impressions is allocated. The method of allocating information to impression map is not limited to that, and setting of the coordinates is preferably changed according to the kind of desired design. Here, with the first impression expression database, a rough impression that covers the whole of the impression map is acquired from a user, and the impression can be used for deciding an impression that is a target of the document creation.

Here, as shown in FIG. 6, the desired impression input image 1002A, for which adjectives read out from the first impression expression database are listed, is displayed on the output section 16.

At the step S10b, the client selects information according to an impression required for the design by using the input section 14. Here, the client causes the user to select an option matching the impression that is a target of the design creation among the options displayed based on the first impression expression database.

The client of the document creation selects one by moving a mouse pointer 5 superimposed on the desired impression input image 1002 by using a mouse as the input section 14 and clicking the mouse as placed on the mouse pointer 5 on the check box 28 provided for adjectives appropriate for the impression required for the design. In the selected check box 28, a check mark is displayed. When selection is done, character information of the selected adjective is saved in the storage section 12 as the mouse pointer 5 is moved to the place of the determined button 29 and the mouse is clicked on it. In the example of FIG. 6, character information such as “peace”, “placid”, and “fresh” is selected and saved in the storage section 12.

The method of selecting information representing images is not limited to that and other methods can be used as long as the method enables a client to easily input.

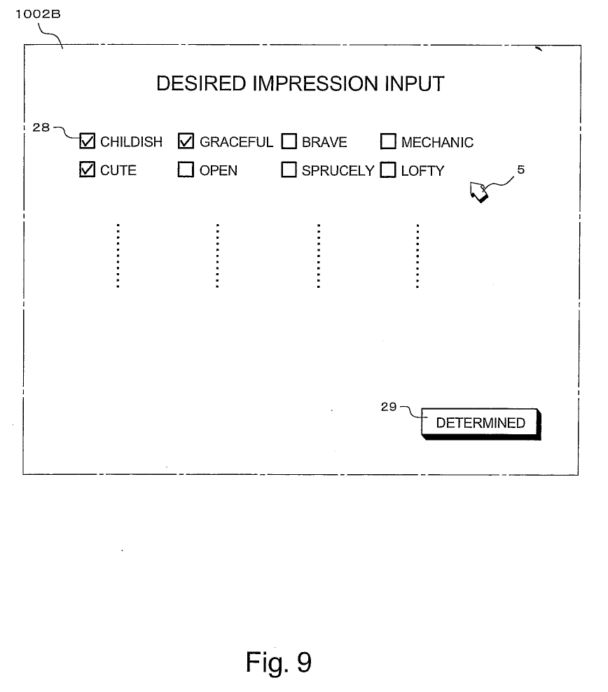

At the step S10c, the control section 10 causes the output section 16 to display the desired impression input screen 1002B. The desired impression input screen 1002B presents a plurality of items of information that represent an impression of the design and permit the client to select information matching the impression that is a target of the design creation as shown in FIG. 9.

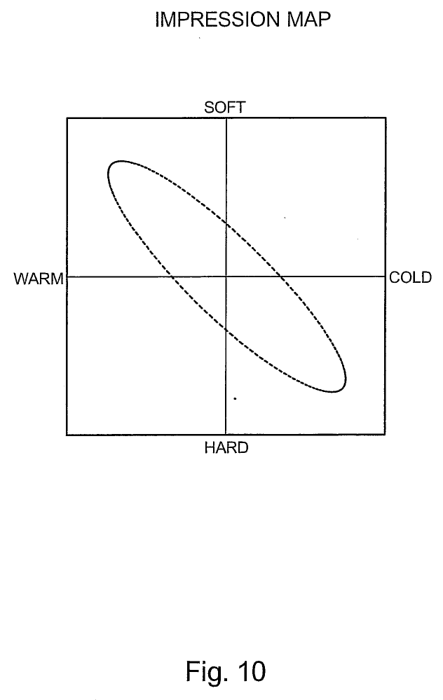

In the exemplary embodiment, an impression of the document is acquired from a user by using the second impression expression database of FIG. 7B. The second impression expression database includes an adjective that describes some regions in the impression map shown in FIG. 8 (regions surrounded by the dotted line in FIG. 10) in more detail than the first impression expression database as shown in FIG. 10. That is to say, by using the second impression expression database, information on a more detailed impression can be acquired from the user according to another tendency that does not go along the two orthogonal coordinates of the impression map (here, a tendency of the design from “friendliness” to “reliability” that comes from the upper left to the lower right of the impression map) to decide a desired impression.

Here, the output section 16 is caused to display the desired impression input screen 1002B on which adjectives read out from the second impression expression database are listed as shown in FIG. 9.

At the step S10b, the client selects information according to the information required for the design by using the input section 14. Here, the user is caused to select an option matching an impression that is a target of the design creation from the options displayed based on the second impression expression database. As the processing here is the same as that at the step S10b, it will be omitted from the detailed description. In FIG. 9, character information such as “childish”, “cute” and “graceful” is selected and saved in the storage section 12.

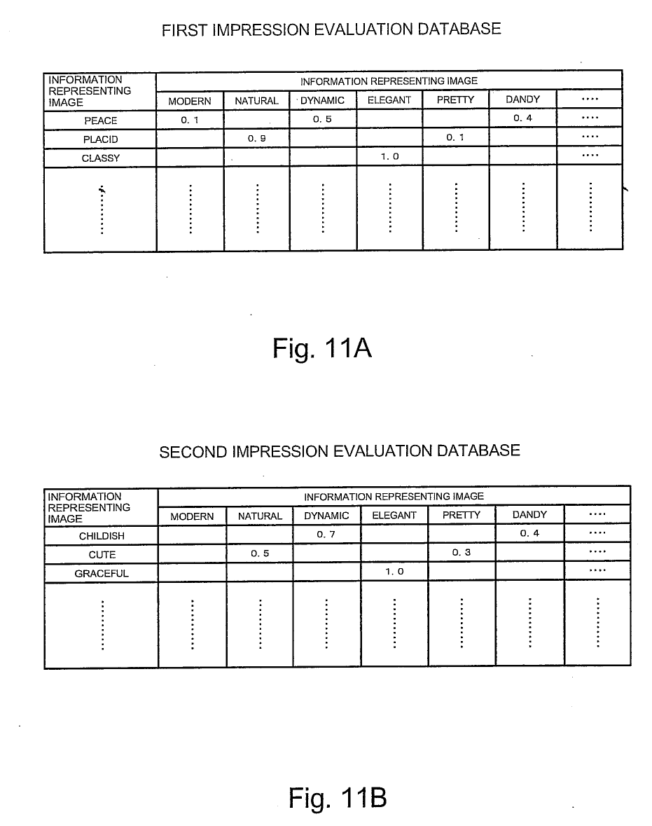

Next, at the step S10e, the desired impression information in the design creation of the document is defined based on the information selected at the steps S10b and S10d. For deciding the desired impression information, the impression evaluation database is used. The impression evaluation database is provided for various impression expression databases as in FIG. 11A,B, and impression information is associated with information included in various impression expression databases, and held there.

The control section 10 reads information selected at the step S10b from the storage section 12 and references the first impression evaluation database shown in FIG. 11A to extract impression information associated with the read out information. The extracted impression information is saved in the storage section 12 in association with the identification number of the design.

For example, the selected character information is “placid”, in the example of the first impression evaluation database of FIG. 11A, “natural” is selected by a ratio of 0.9 and “pretty” is selected by a ratio of 0.1 as impression information.

Similarly, the control section 10 reads the information selected at the step S10d from the storage section 12 and references the second impression evaluation database shown in FIG. 11B to extract the impression information associated with the read information. The extracted impression information is saved in the storage section 12 in association with the identification number of the design.

For example, if the selected character information is “cute”, in the example of the second impression evaluation database in FIG. 11B, “natural” is selected by a ratio of 0.5 and “pretty” is selected by a ratio of 0.3 as impression information.

The control section 10 calculates a product of values obtained by the processing for each section of each item of impression information. In the example above, as 0.9 is acquired from the first impression evaluation database and 0.5 is acquired from the second impression evaluation database for the impression information “natural”, 0.9×0.5=0.45 is calculated. Products are also calculated for another item of impression information in the same manner. Then, the impression information with the highest value is determined as the final desired impression information. When the desired impression information is determined, the control section 10 returns control to step S0.

### <Modification>

The processing of the desired impression deciding step is not limited to that described above. For example, if plural colors are used in the object of the design such as a presentation material, a web page, an appearance of a new material or a brand logo of a company, a group of color pallets that is a combination of colors or plural abstract images for giving different impressions to a person are registered as an impression expression database so that they are listed on the desired impression input screen to permit a client to make selection on the list, and desired impression information associated with the selected color palette can be selected.

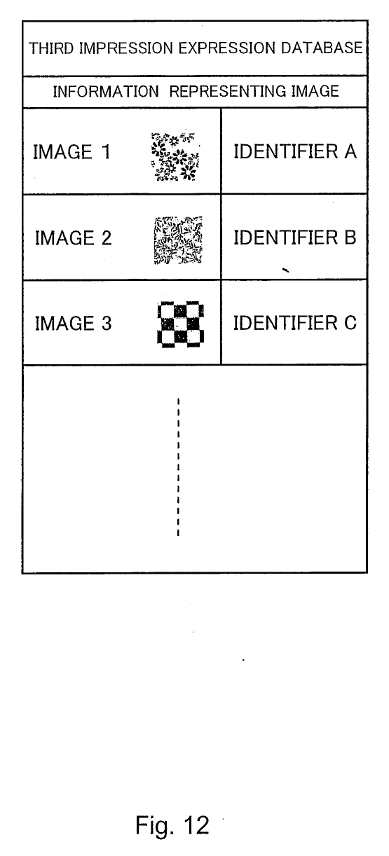

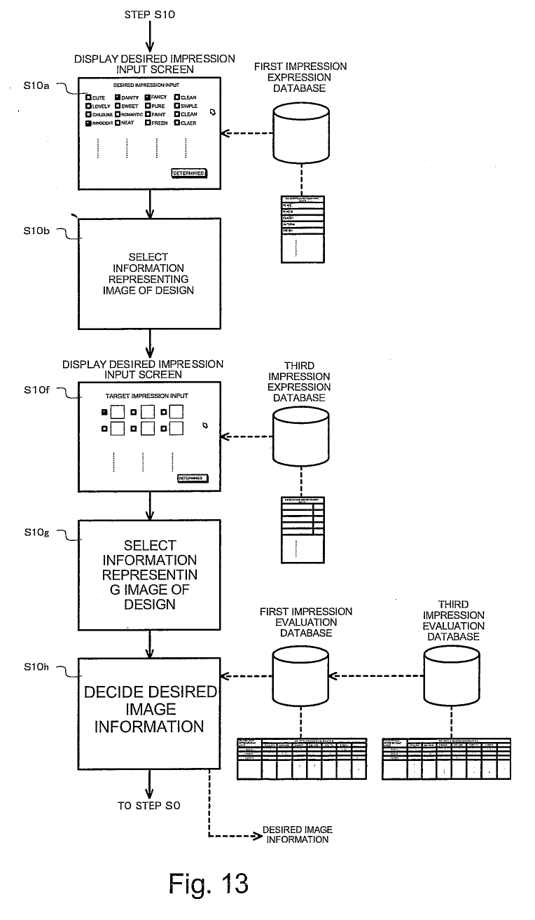

A case where the processing is performed by using the first impression expression database registering character information including adjectives shown in FIG. 7A and the third impression expression database registering plural abstract images shown in FIG. 12 will be described. In the modification, the step S10 is processed according to the flowchart shown in FIG. 13.

At the steps S10a and S10b, an impression of the document is acquired from the user by using the first impression expression database of FIG. 7A as in the above-mentioned desired impression decision process. The processing here is omitted from the description.

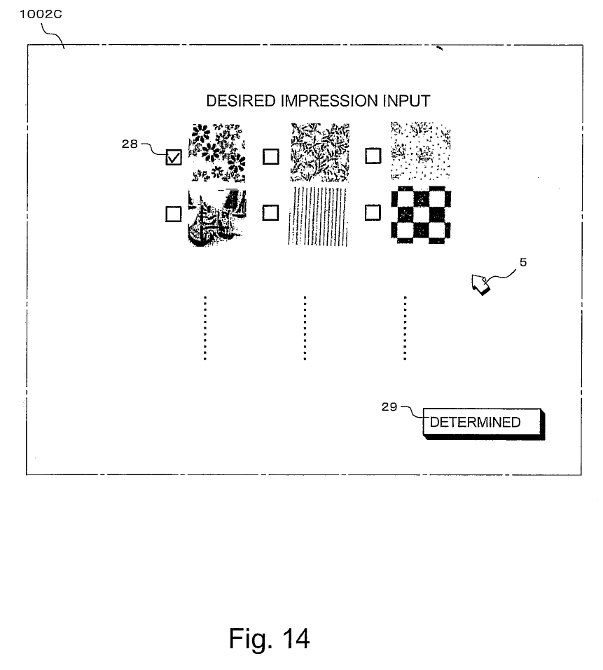

At the step S10f, the control section 10 causes the output section 16 to display the desired impression input screen 1002C. The desired impression input screen 1002C presents plural abstract images that represent an impression of the design as shown in FIG. 14 for a client to select an abstract image matching the impression that is a target of the design creation.

In the exemplary embodiment, an impression of the document is acquired from the user by using the third impression expression database of FIG. 12. The third impression expression database includes plural abstract images that cover at least some regions on the impression map as shown in FIG. 12. That is to say, the first impression expression database is for letting the user select an impression of the document by realized character information and letting the user select an impression of the document by an abstract image in the third impression expression database to decide an impression more appropriate as an impression that is a target of the design creation.

Here, as shown in FIG. 14, the output section 16 is caused to display the desired impression input image 1002C in which the abstract images read out from the third impression expression database are listed.

At the step S10g, the client selects information according to the impression that is required for the design by using the input section 14. As the processing here is the same as that at the step S10b, it is omitted from the description. In the example of FIG. 14, the first abstract image 1 is selected and its identifier A is saved in the storage section 12.

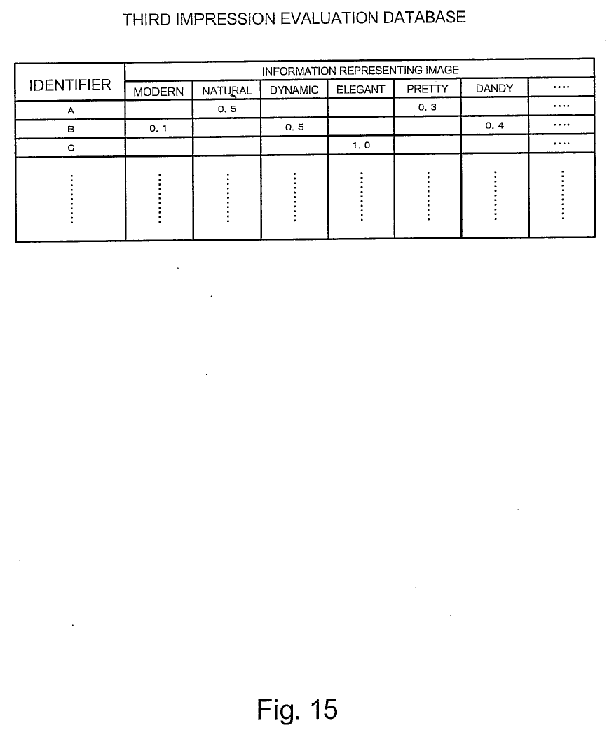

At the step S10h, the desired impression information in the design creation of the document is defined based on the information selected at the steps S10b and S10g. For deciding the desired impression information, the impression evaluation database is used. The impression evaluation database is provided for each impression expression database as shown in FIG. 11A and FIG. 15, and the impression information is associated and kept for information included in each impression expression database.

The control section 10 reads the information selected at the step S10b from the storage section 12 and references the first impression evaluation database shown in FIG. 11A to extract impression information associated with the read out information. The extracted impression information is saved in the storage section 12 in association with the identification number of the design. For example, the selected character information is “placid”, in the example of the first impression evaluation database of FIG. 11A, “natural” is selected by a ratio of 0.9 and “pretty” is selected by a ratio of 0.1 as impression information.

Similarly, the control section 10 reads the identifier of the abstract image selected at the step S10g from the storage section 12, and references the third impression evaluation database as shown in FIG. 15 to extract impression information associated with the read identifier. The extracted impression information is kept in the storage section 12 in association with the identification number of the design.

For example, if the selected character information is the abstract image 1, in the example of the third impression evaluation database of FIG. 15, “natural” is selected by a ratio of 0.5 and “pretty” is selected by a ratio of 0.3 as impression information registered in association with the identifier A of the abstract image 1.

The control section 10 calculates a product of values acquired by the processing for each section of each impression information. In the above-mentioned example, as 0.9 is acquired from the first impression evaluation database and 0.5 is acquired from the third impression evaluation database for the impression information “natural”, 0.9×0.5=0.45 is calculated. Products are also calculated for another item of impression information in the same manner. Then, the impression information with the highest value is determined as the final desired impression information. When the desired impression information is determined, the control section 10 returns the control to the step S0.

Although it is assumed that the desired impression information is defined based on the information selection only by a client in the exemplary embodiment, it is also preferable to define the desired impression information based on the information acquired from plural persons by repeating the above-mentioned processes. For example, it is quite effective in extracting desired impression information on a corporate color of the company from plural company officials or in extracting desired impression information on the design of the commodity product from plural persons in charge of developing a commodity product. In such a case, impression information is extracted for each client, a product of values is calculated for each impression information extracted for each client and products of values of impression information for plural clients are added up for each item of impression information to make the impression information with the biggest sum the desired impression information.

It is also preferable to define the desired impression information in consideration of any change in the impression the client received from the design as a client repeats the process over a period of time. In such a case, a product value that is a sum of weighting factors is calculated for each item of impression information extracted each time the processing is performed, a product value of the impression information is added for each item of the impression information to make the impression information with the biggest sum the desired impression information.

### 2-2. Design Impression Evaluation Process

When the design impression evaluation button 22 is clicked at the step S0, the processing proceeds to the design impression evaluation process at the step S20.

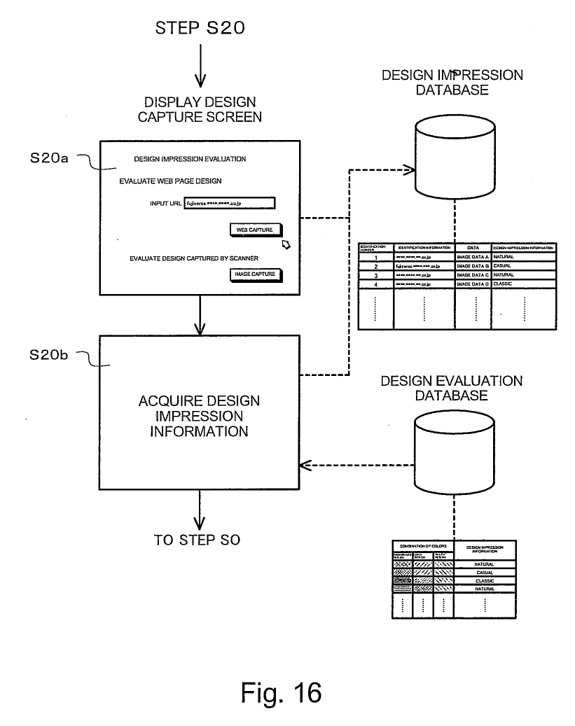

In the design impression evaluation process at step S20, information on the impression of the design of the document (hereinafter, referred to as design impression information) is extracted. The design impression evaluation process is processed according to the flowchart of FIG. 16.

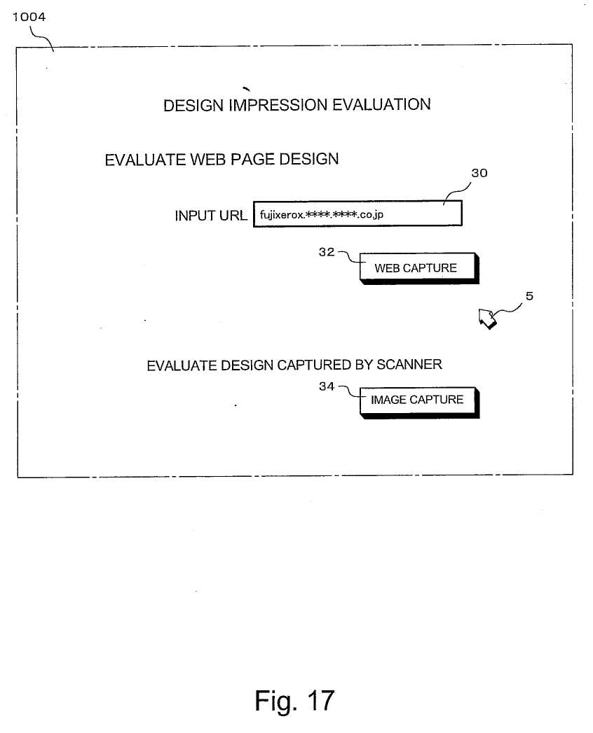

First at the step S20a, the actual document data is captured and stored, and kept in the storage section 12. The control section 10 displays the design capture screen 1004 on the output section 16 as shown in FIG. 17 and prompts the design creator to input the document relating to the design that is to be evaluated.

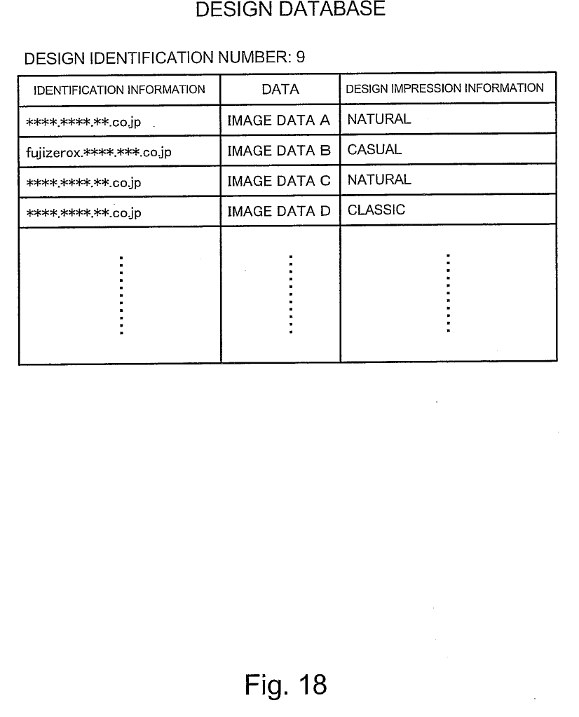

For example, the design creator designs a web page and uploads it on the network 104 in advance. Next, a place for acquiring the web page that is subjected to the design impression evaluation is specified by inputting the URL of the web page in the URL input box 30 of the design capture screen 1004, the mouse pointer 5 displayed on the design capture screen 1004 being moved to the web design fetching button 32, and the mouse being clicked. When the control section 10 receives the specification, it captures document data of the web page from the specified URL via the network 104. The captured document data is accumulated in the storage section 12 as a design database in association with the identification information (for example, URL) of the document data in order as shown in FIG. 18.

If no design database is generated for the identification number of the design, a new design database is generated in association with the identification number of the design. On the other hand, if a design database is present for the identification number of the design, identification information of the document data and the document data are additionally accumulated for the existing design database.

It is possible to fetch the document data of the web page and evaluate it by specifying the URL of not only the created web page but also the web page of a competing company for example.

If the object of the design creation is the presentation material, a new product or a company brand logo or the like, it is also preferable to fetch the document data by using a reading device such as a scanner or the like. In such a case, it is preferable to activate the existing document reading tool by clicking the document fetching button 34 of the design capture screen 1004.

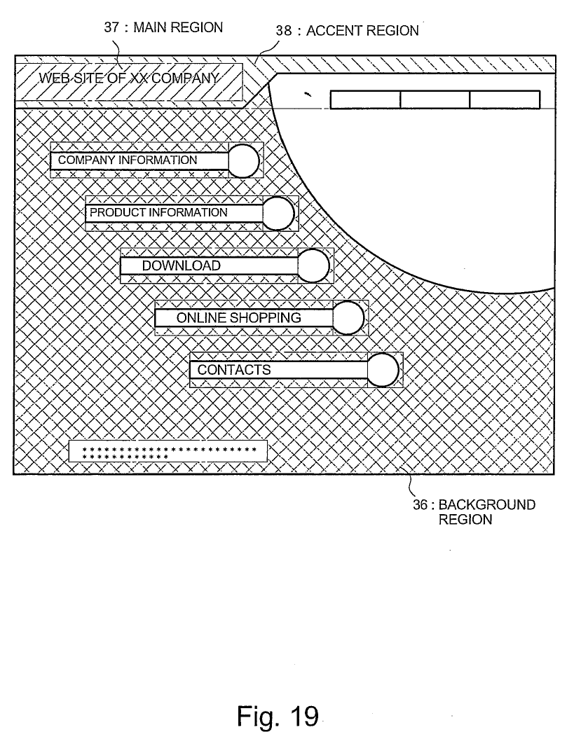

In the description below, it is assumed that a document of the web page of FIG. 19 is captured as an example.

At the step S20b, evaluation of an impression that the captured document data gives to a person is performed. For evaluating the impression of the design, an existing evaluation unit such as in Japanese Patent Application No. 2002-187522 can be used.

That is to say, the control section 10 reads image data of the document to be evaluated from the storage section 12 and divides a region as shown in FIG. 19. For dividing a region, an existing image region dividing tool can be used. Next, the amount of the physical feature such as an area, a place, a size, a color average, and color difference with respect to other regions is extracted for each divided region.

Each region is preferably converted from the RGB color space into L*a*b* color space and then the visual amount of a feature is extracted. Usually, the document data used in a computer is represented in the RGB color space, which is an uneven color space, which means that analyzing with the sensibility of a person cannot be performed. By converting the region from the RGB color space, which is an uneven color space, into the L*a*b* color space, which is an even color space, the region can be analyzed and evaluated as an impression closer that of a person's sensibilities. The L*a*b* color space is also preferable from the viewpoint that it can represent the dynamic range of the document. It is a matter of course that if the document data is already represented in the L*a*b* color space, no conversion is needed.

The amount of a physical feature is the feature such as an area of a region concerned, a width w and a height h of the region concerned, places x and y at the upper left, a color average of the entire region concerned, an average value of the L* component, an average value of the a* component, an average value of the b* component, a color difference ΔL*a*b* between the color average of the entire document and the color average of the entire region concerned, a color difference ΔₙL*a*b* of the color average between the region concerned and the adjacent region, a color difference Δ_{b}L*a*b* of the color average between the background and the region concerned, color distribution in a region concerned, and the number of the regions having the same color. The average color is extracted from the background region of the document data, the main region with the biggest region except for the background region, and an accent region that is an accent to the main region to be the amount of feature.

On the other hand, the combination of the amount of the physical features is stored and kept in the storage section 12 in association with design impression information, as the design evaluation database. For example, as shown in FIG. 2, a set of colors in each of the background region, the main region with the biggest region except for the background region, and the accent region that is an accent to the main region (in the figure, it is indicated by hatching) is generated, and is saved in association with design impression information indicating an impression a person got from the set of the colors.

Based on the design evaluation database, an average color can be extracted from the background region, the main region and the accent region of the actual document data, and the design impression information can be extracted from the set of average colors. The extracted design impression information is stored and saved in the storage section 12 as the design database in association with the identification number of the document data and the document data to be evaluated.

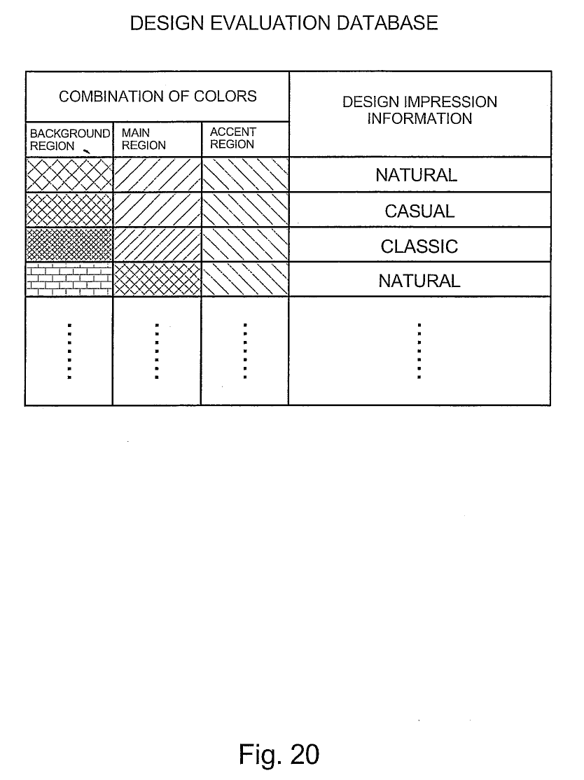

For example, by extracting an average color from each of the background region, the main region and the accent region of the document data of FIG. 19, the design impression information “natural” can be obtained based on the design evaluation database of FIG. 20.

For the amount of features that can be used for extracting information on an impression, an area of the region, a width w and a height h of a region, upper left places x and y, a color average for the entire region, an average value of an L* component, an average value of an a* component, an average value of a b* component, a color difference ΔL*a*b* between a color average for the entire region and a color average for a region concerned, a color difference ΔₙL*a*b* of a color average between the region concerned and an adjacent region, a color difference Δ_{b}L*a*b* of a color average between a background and the region concerned, color distribution in the region concerned, and the number of the regions having the same color may be used.

A multidimensional representing information database in which conditions of combination of the amounts of features and representing information on an impression of a document are associated with each other may be used. As such, by combining the amount of features as much as possible, an impression given by the document to a person may be further detailed. Particularly, with conditions including difference among the amounts of features between the different document regions, such as a color difference between document regions, representing information representing an impression got from a part or the like with a strong contract in the document to be evaluated can be extracted.

It is also preferable to make the amount of the physical features acquired from the document data the design impression information. For example, a combination of average colors of the background region, the main region and the accent region of the document data may preferably be the design impression information as a color palette.

As the design impression is selected, the design impression evaluation process is finished and the control section 10 returns the control to the step S0.

### 2-3. User Impression Acquisition Process

When the user clicks the user impression acquisition process button 24 at the step S0, the processing proceeds to the user impression acquisition process at the step S30.

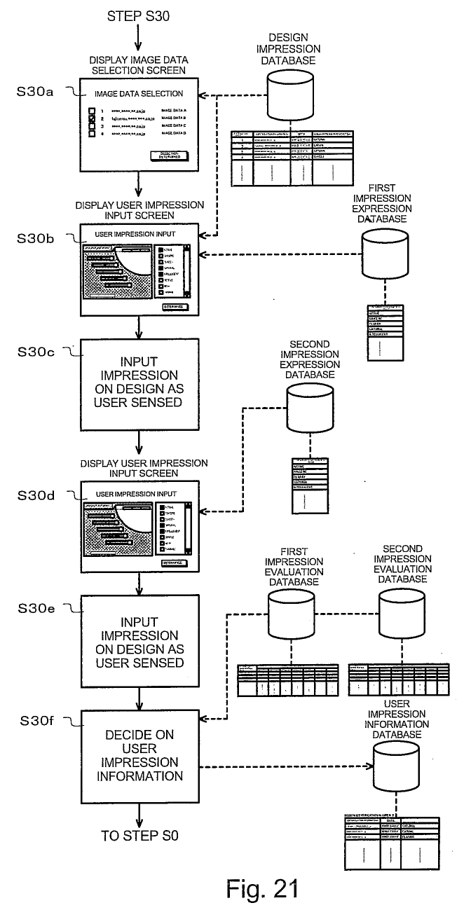

In the user impression acquisition process at the step S30, an impression the user got from the document data captured at the step S20 (hereinafter, referred to as the user impression information) is acquired. The user impression acquiring process is processed according to the flowchart shown in FIG. 21.

At step S30a, the control section 10 causes the output section 16 to display the document data selection screen 1006A, and prompts to select the document data to be subject to the impression acquisition among the document data captured at the step S20.

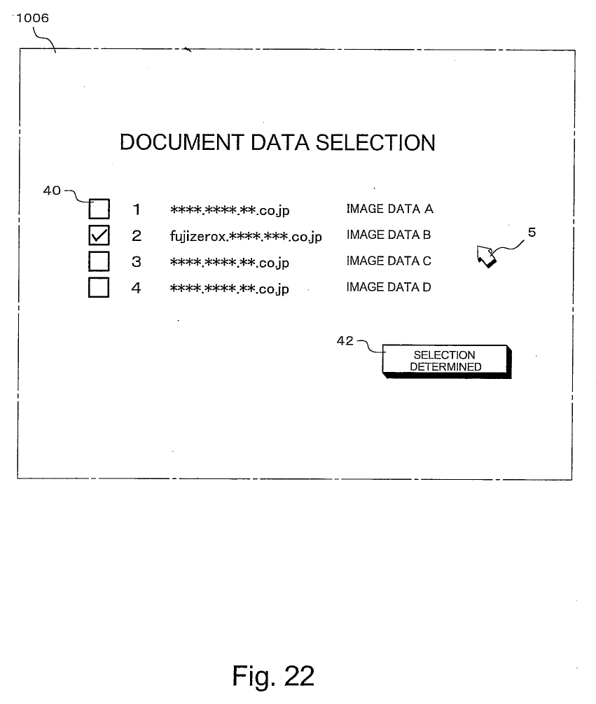

It is preferable for the document data selection screen 1006 to display the list of information on the document data kept in the design database of the storage section 12 on the screen as shown in FIG. 22 for allowing the user impression information, for which document data is to be acquired, be selected. An aspect of the document data selection screen 1006 is not limited to that described above, and any screen can be used as long as the screen can select the document data kept in the design database.

The user who inputs an impression for the document data selects the information by moving the mouse pointer 5 to the check box 40 provided for each item of information relating to the document data (image data) of the document data selection screen 1006 by using the input section 14 such as a mouse or the like and clicking the mouse. Next, the user confirms the selection of the document data by moving the mouse pointer 5 to the selection determined button 42 and clicking the mouse.

At the step S30b, the control section 10 displays the user impression input screen 1008A on the output section 16 and prompts to input an impression the user got from the sight of the document data.

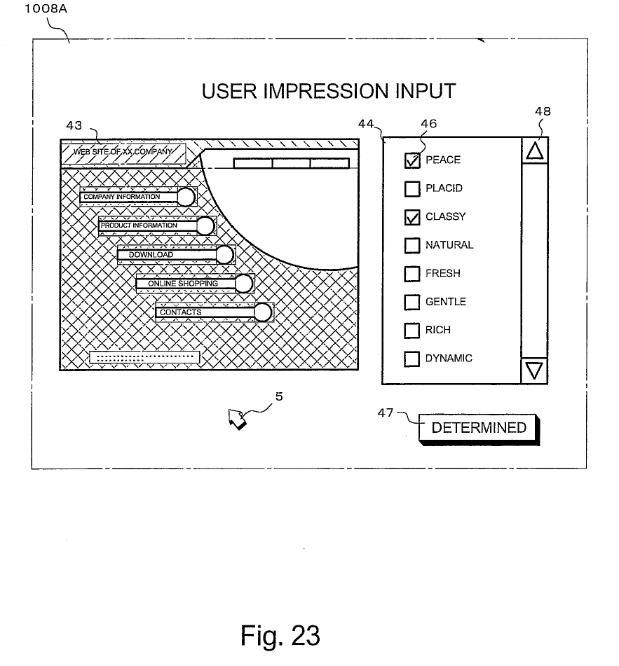

The user impression input screen 1008A is divided into a region 43 that displays the contents of the selected document data and a region 44 that displays a list of the information representing impressions of the design as shown in FIG. 23.

The control section 10 reads the document data selected at the step S30a from the design database kept in the storage section 12, and forms an image of the document data in the document data displaying region 43 to be displayed. For example, if the document data of the web page is selected, the URL of the document data is read from the design database, and the document data is captured from the URL and displayed on the display as shown in FIG. 23.

Further, the control section 10 reads information representing an impression of the design from the impression expression database kept in the storage section 12 and displays it in the impression representing displaying region 44. The information representing an impression included in the impression expression database is preferably selected and used as required according to the kind of document data from color information or the like including a color palette including sets of plural adjectives and colors representing an impression of the design, as in the desired impression deciding process at the step S10.

In the exemplary embodiment, character information including plural adjectives are read from the first impression information database and displayed on the impression representing displaying region 44.

Next, at the step S30c, the user selects information matching the impression the user got when viewing the design of the document displayed on the document data displaying region 43 by using the input section 14.

For example, as shown in FIG. 23, the mouse pointer 5 is displayed in the impression representing displaying region 44 in which adjectives are listed, the user uses a mouse to move the mouse pointer 5 to the check box 46 provided for the adjective matching an impression the user got from the design and clicks the mouse and select it. A check mark is displayed in the selected check box 46. The display of adjectives can be changed as required as the mouse pointer 5 is moved on the scroll button 48 and the mouse is clicked. When the selection of adjectives finishes, character information for the selected adjectives is saved in the storage section 12 once the mouse pointer 5 is moved to the place of the determined button 47, and the mouse is clicked. For example, character information “peace” and “classy” is selected in FIG. 23 and saved in the storage section 12.

A method for acquiring an impression of the user is not limited to that described above. That is to say, any method can be adopted as long as it enables a user to easily input an impression for the design of the document data.

At the step S30d, the control section 10 causes the output section 16 to display the user impression input screen 1008B and prompts to input an impression the user got from the document data.

The user impression input screen 1008B is divided into a region 43 that displays the contents of the selected document data and a region 44 that displays a list of information representing an impression of the design. The user impression input screen 1008B is displayed as in the step S30b except for the processing of reading information representing an impression of the design from the second impression expression database kept in the storage section 12, and displaying the information in the impression expression display region 44.

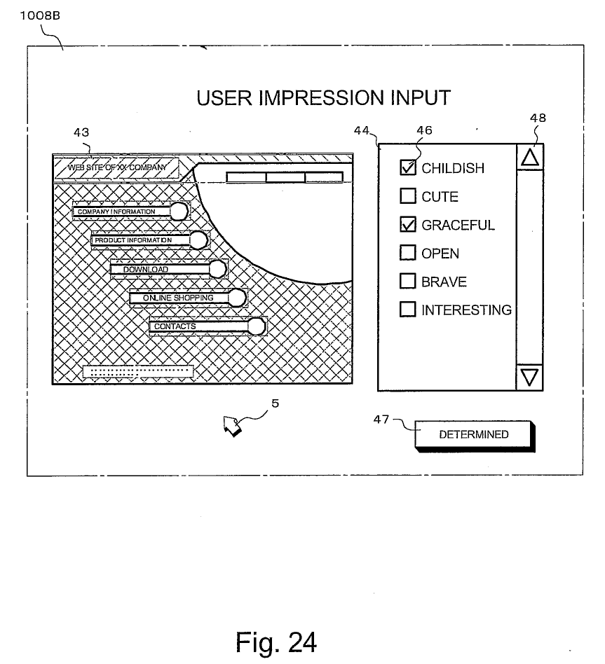

Next, at the step S30e, the user selects information matching an impression the user got from the design of the document displayed in the document data displaying region 43 by using the input section 14. The step S30e is processed as the step S30c by using the user impression input screen 1008B of FIG. 24. In the example of FIG. 24, character information “childish” and “graceful” is selected and saved in the storage section 12.

Next, at step S30f, the user impression information is defined based on the information selected at the steps S30c and S30e. For deciding the user impression information, the impression evaluation database used at the desired impression decision process at the step S10 is used. The impression evaluation database is provided for each impression expression database and impression information is kept in association with information included in each impression expression database, as in FIG. 11A,B.

The control section 10 reads information selected at the step S30c from the storage section 12 and references the first impression evaluation database shown in FIG. 11A to extract the impression information associated with the read information. The extracted impression information is saved in the storage section 12 in association with the identification number of the design. The control section 10 reads the information selected at the step S30e from the storage section 12 and references the second impression evaluation database shown in FIG. 11B to extract impression information associated with the read information. The extracted impression information is saved in the storage section 12 in association with the identification number of the design.

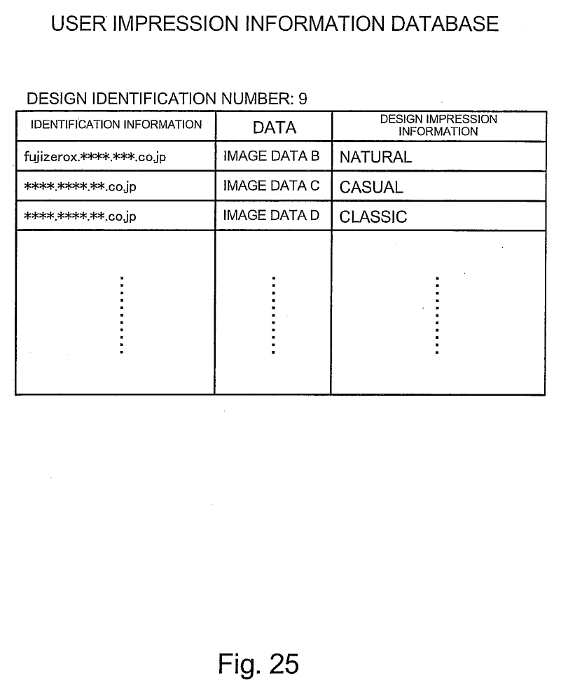

The control section 10 calculates a product of values obtained by the processing for each section of each impression information. It decides the impression information with the biggest value as the final user impression information. When the user impression information is decided, it is saved in the storage section 12 as the user impression information database in association with the document data as shown in FIG. 25.

If no user impression information database has been generated, the user impression information database for each identification number of the design is generated. On the other hand, if the user impression information database is present for the identification number of the design, the document data and the user impression information are added to the existing user impression information database.

When the user impression information is selected, the user impression acquisition process is finished, and the control section 10 returns the control to the step S0.

### <Modification>

The processing of the user impression decision process is not limited to that described above. For example, if plural colors are used in the object of the design such as a presentation material, a web page, an appearance of a new product or a brand logo of a company, a group of color pallets that is a combination of colors or plural abstract images for giving different impressions to a person are registered as an impression expression database so that they are listed on the user impression input screen so as to permit a client to make a selection from the list, impression information associated with the selected color palette can be selected.

For example, if the processing is done by using the third impression expression database in which plural abstract images are registered as shown in FIG. 12, plural abstract images registered in the third impression expression database are read and displayed in the impression expression display region 44 on the user impression input screen. Then, the user is allowed to select information matching an impression the user got from the design of the document displayed on the document data display region 43 by using the input section 14.

Then, the user impression information indicating the impression the user got from the document is defined based on the selected information. The impression evaluation database is used for deciding the desired impression information. The impression evaluation database is provided for various impression expression databases as in FIG. 15, and impression information is associated with information included in various impression expression databases and kept there. The control section 10 calculates a product of values obtained through the processing of each section of each item of impression information, and determines the impression information with the biggest value as final user impression information. When the user impression information is determined, the control section 10 returns the control to the step S0.

Although the user impression information is assumed to be defined based on the information selection only by a user in the exemplary embodiment, it is also preferable to define the user impression information based on information acquired from plural persons by repeating the above processes. That enables an objective and wide evaluation of the impression of the document data. The user impression information can be preferably defined by repeating the above-mentioned process with a time period by a single user.

### 2-4. Impression Presentation/Correction Process

When the impression presentation/correction process button 26 is clicked at the step S0, the processing proceeds to the impression presentation/correction process at the step S40.

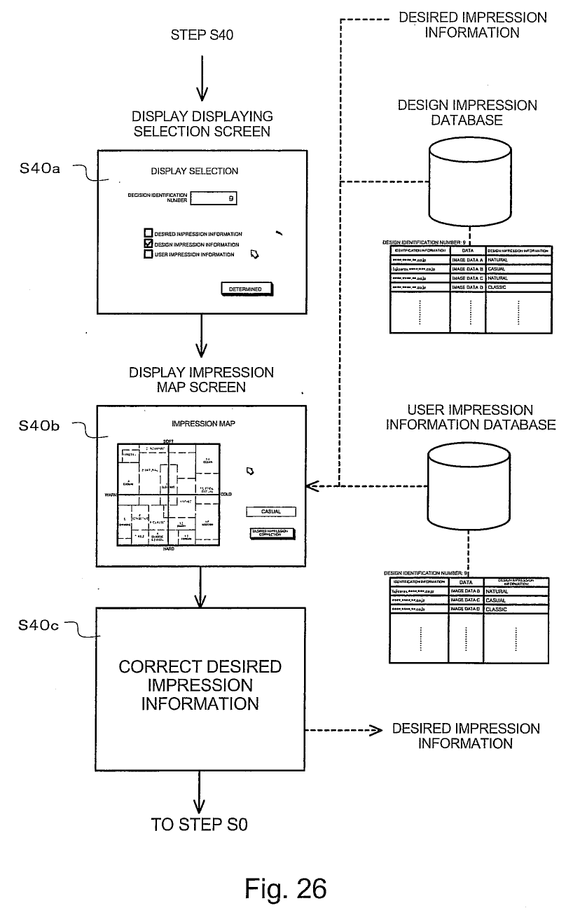

The impression presentation/correction process at the step S40 is executed according to the flowchart shown in FIG. 26 and the desired impression information obtained at the step S10, the design impression information obtained at the step S20 and the user impression information obtained at the step S30 are displayed.

First, at the step S40a, the control section 10 causes the output section 16 to display the display selection screen 1010 and lets an operator select the information to be displayed.

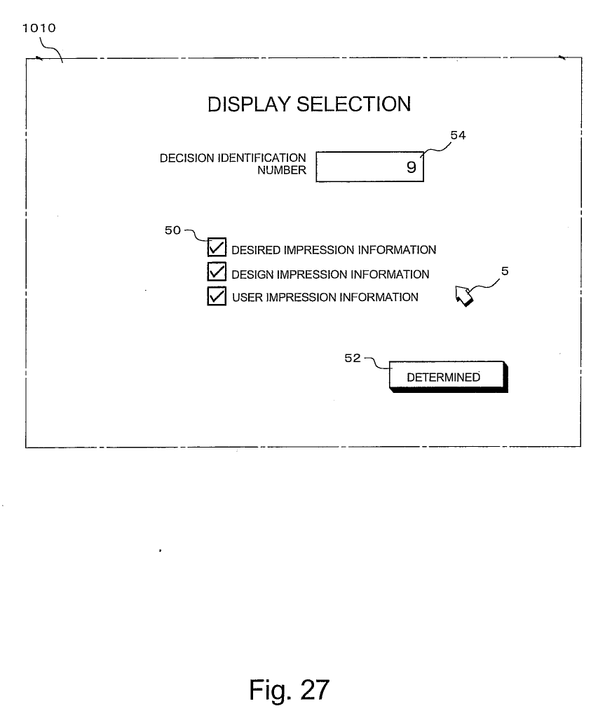

On the display selection screen 1010, as shown in FIG. 27, the identification number of the design to be displayed is input in the input box 54. Information to be displayed is selected from the desired impression information, the design impression information and the user impression information by selecting the check box 50 with the mouse and clicking on the determined button 52.

Next, the control section 10 which receives the input of the information to be displayed causes the impression map screen 1012 to display the desired impression information, the design impression information, and the user impression information in step S40b.

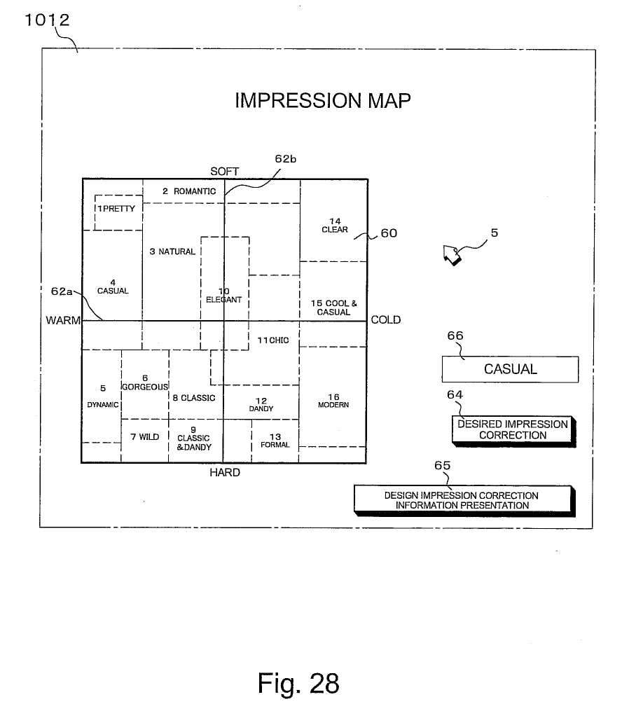

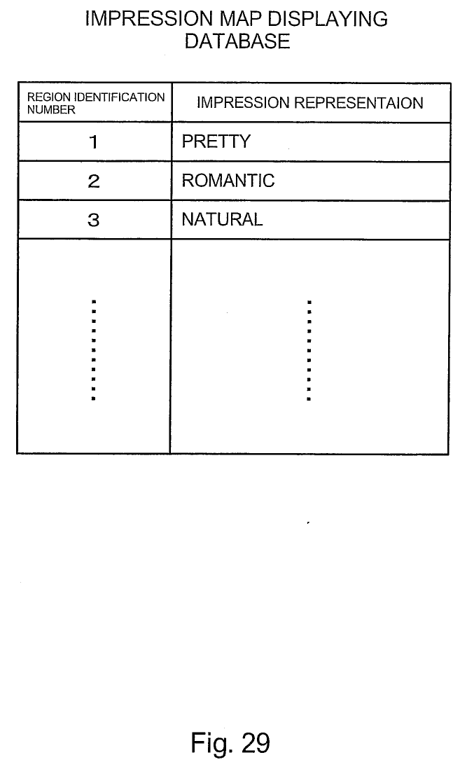

The impression map screen 1012 is divided into plural regions, each of which has a region identification number as shown in FIG. 28. On the other hand, the storage section 12 keeps information representing an impression for each region identification number as an impression map displaying database as shown in FIG. 29.

The control section 10 extracts the region identification number in association with the desired impression information, the design impression information or the user impression information by referencing the impression map displaying database. Then, it displays each item of information corresponding to the region on the impression map screen 1012 which has the extracted region identification number.

Here, it is preferable to provide coordinates for the impression map screen 1012 and allocate the region identification number so that an impression changes in a predetermined tendency along the coordinates.

For example, in the example of the impression map screen 1012 shown in FIG. 28, two orthogonal coordinates of an X coordinate indicating warmth of the design from “warm” to “cold” and a Y coordinate indicating hardness of the design from “soft” to “hard” are provided and information representing impressions according to change in respective impression is allocated. The method of allocating information to the impression map screen 1012 is not limited to that described above, and setting of the coordinates can be changed according to the kind of objective design.

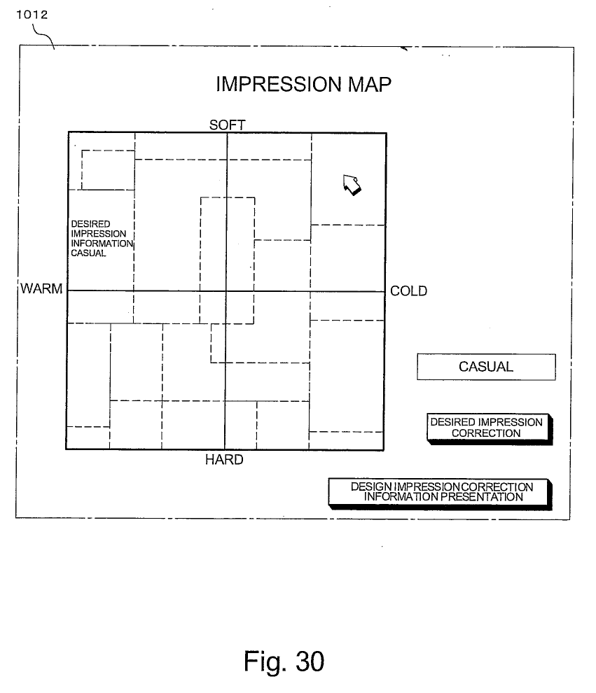

If the desired impression information is selected at the step S40a, as shown in FIG. 30, the desired impression information in association with the design identification number is superimposed on the impression map screen 1012.

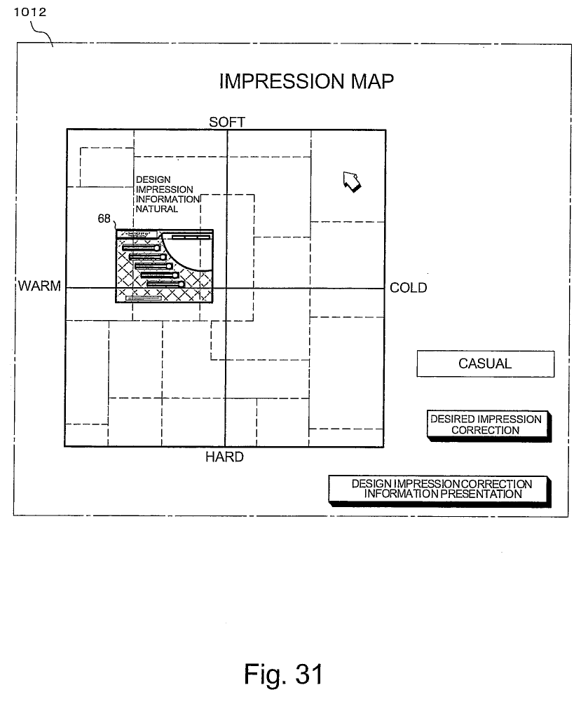

If the design impression information is selected at the step S40a, as shown in FIG. 31, the design impression information included in the design database associated with the design identification number is superimposed on the impression map screen 1012. Here, it is preferable to facilitate identification of the displayed information by such processing as changing a displayed color of the information for each document data included in the design database. Alternatively, it is also preferable to display the document data corresponding to each item of design impression information instead of or in addition to each item of design impression information.

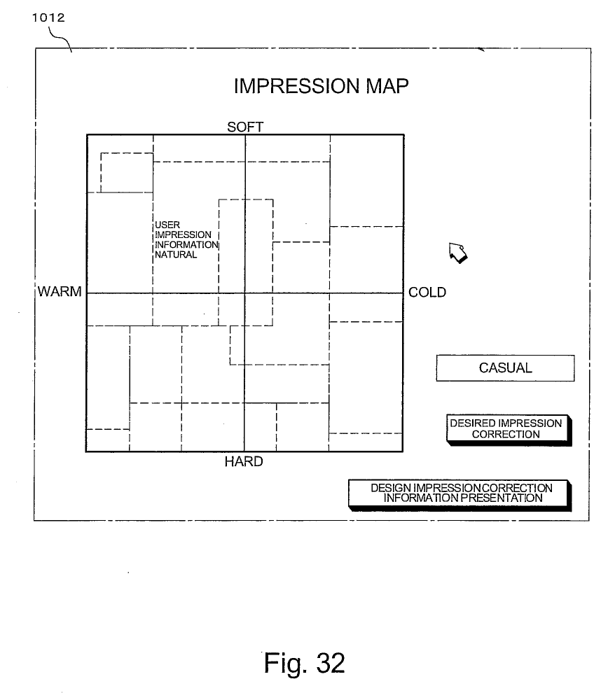

When the user impression information is selected at the step S40a, as shown in FIG. 32, the user impression information included in the user impression information database associated with the design impression identification number is superimposed on the impression map screen 1012. Here, it is preferable to facilitate identification of the displayed information by such processing as changing a displayed color of the information for each document data included in the user impression information database.

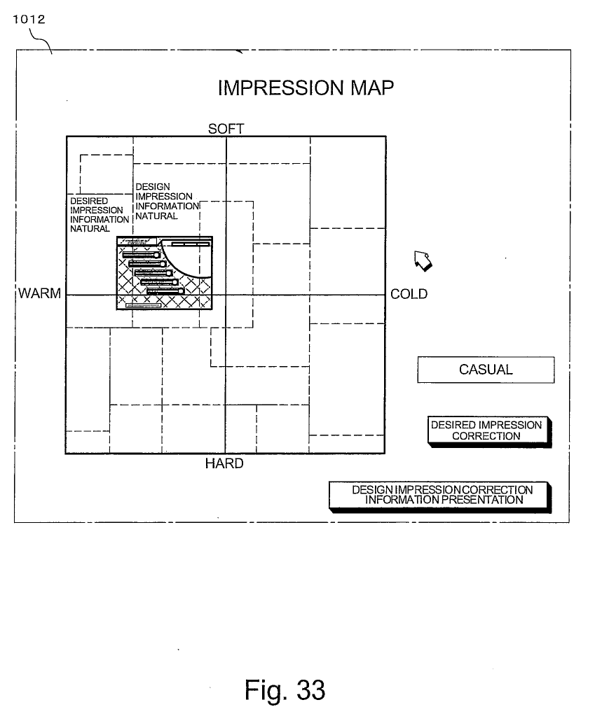

If both of the desired impression information and the design impression information are selected at the step S40a, as shown in FIG. 33, both of the desired impression information and the design impression information associated with the design identification number are superimposed on the impression map screen 1012. Similarly, if both of the desired impression information and the user impression information are selected, if both of the design impression information and the user impression information are selected, or if all of the desired impression information, the design impression information and the user impression information are selected, each item of information is superimposed on the impression map screen 1012.

As such, by superimposing the desired impression information, the design impression information and the user impression information on one impression map screen 1012, the design creator, the client and the user can visually compare and recognize the impression to be subjected to the design creation, an impression included in the actual design and an impression the user got from the actual design. Here, as each item of information is displayed along the coordinate indicating the impression tendency on the impression map screen 1012, how much of a difference there is among the desired impression, the impression of the actual design and the impression the user got, what kind of tendency the difference has, and the like, can be clearly recognized.

Further, by obtaining the design impression information for the other company's web page or the design of another product at the step S20, those items of information and the desired impression information can be compared with each other and recognized. That facilitates recognition matching or difference among the impression of other company's web page or the impression of another product and the desired impression of the design to be created.

Further, by acquiring the user impression information from plural users for the same design at the step S30, the distribution tendency of the user impression information can be easily recognized on the impression map screen 1012. Whether the desired impression information or the design impression information matches with the distribution tendency of the user impression information can be recognized at a glance.

An abstract image may be associated with each region on the impression map screen 1012 and displayed instead of or in addition to an adjective in a region corresponding to the desired impression information, the design impression information and the user impression information as the desired impression information, the design impression information and the user impression information. This is the same in the case where the color palette is used.

Further, in the exemplary embodiment, correction of the desired impression information or presentation of the information that helps the correction of the design impression can be performed. By moving the mouse pointer 5 onto the desired impression correction button 64 or the design impression correction information presentation button 65 on the impression map screen 1012 and clicking the mouse, the processing proceeds to the step S40c.

As the correction of the desired impression information is instructed, the control section 10 starts setting processing for the desired impression information.

The operator moves the mouse pointer 5 in the region of the impression map screen 1012 and clicks the mouse by referencing the design impression information or the user impression information displayed on the impression map screen 1012. The control section 10 acquires the position of the mouse pointer 5 and references the impression expression database to set information representing the impression allocated to the region as new desired impression information. Here, it is also preferable to provide a region 66 for displaying the desired impression information and display the desired impression information to facilitate checking of the newly set desired impression information.

With the above-mentioned desired impression information setting method, it is possible to superimpose the web design of a competing company on the impression map screen 1012 as the design impression information, and when the desired impression of the web design of the user's own company is desired to be different from the web design of the competing company, an appropriate desired impression information can be easily set by specifying a region that does not overlap with the region in which the design impression information of the web design of the competing company is displayed. In contrast, if it is desired to easily set appropriate desired impression information like that of the competing company, an appropriate desired impression information can be set by specifying the region in which the design impression information of the web design of the competing company is set. Similarly, by superimposing the user impression information on the impression map screen 1012, new desired impression information can be set with reference to the impression received by the user.

By moving the mouse pointer 5 to the design impression correction information presenting button 65 provided on the impression map screen 1012 and clicking the mouse, an operator can present information required for correcting the design impression information. For example, it is preferable to make a color combination of the background, the main region, and the accent region of the design appropriate for the impression allocated to each region of the impression map screen 1012 into a database in advance, and superimpose the set of colors corresponding to the region in which the desired impression information is displayed on the impression map screen 1012. By changing the design into the displayed color combination, it can be made closer to the desired impression.

In this manner, by performing presentation of the supporting information of the correction of the desired impression information or the correction of the design on the same impression map screen 1012, a task can be performed by visually recognizing the desired impression, an impression included in the actual design, and an impression the user receives from the actual design.

That is to say, according to the exemplary embodiment, whether an impression to be subjected to the design creation matches the impression included in the actual design and the impression the user got from the actual design or not can be recognized on the same impression map screen.

That enables the client or the design creator to visually recognize whether the desired impression setting of the design creation is appropriate or not and easily correct the desired impression or the design impression. In the task of design creation, the client and the design creator easily negotiate information so that they can smoothly perform the tasks.

Further, based on the impression desired by the client or the impression the user got from the created design, the orientation of the design correction can be easily found.

Although a visual design such as a web page, a presentation material, a product design and the like are mentioned in the above-mentioned exemplary embodiment, the same effect can be obtained by also acquiring the desired impression information, the design impression information and the user impression information for audio data such as commercial audio and the like, and displaying them on the same impression map screen.

What is claimed is:

1. A computer readable recording medium storing a design creation supporting program causing a computer having a memory that stores a plurality of impression expression databases, including a group of options that represent an impression of a document wherein the group of options are different, and an impression evaluation database in which impression information got by a person as the person views a document is associated with the options included in the plurality of impression expression databases, to execute a process for supporting design creation, the process comprising:
causing a user to select and acquire at least one option matching an impression that is the target of the design creation of the document from each of the plurality of impression expression databases; and
extracting impression information associated with the option selected from the plurality of impression expression databases by referencing the impression evaluation database and making at least one item of the extracted impression information as the desired impression information that represents an impression that is a target of the design creation of the document.

2. A computer readable recording medium storing a design creation supporting program causing a computer having a memory that stores a plurality of impression expression databases, including a group of options that represent an impression of a document wherein the group of options are different, and an impression evaluation database in which impression information got by a person as the person views a document is associated with the options included in the plurality of impression expression databases, to execute a process for supporting design creation, the process comprising:
causing a user to select and acquire at least one option matching an impression that is actually got from the design of the document from each of the plurality of impression expression databases; and
extracting impression information associated with an option selected from the plurality of impression expression databases by referencing the impression evaluation database and making at least one of the extracted impression information the user impression information that represents an impression given by the design of the document.

3. The recording medium according to claim 1, wherein
the plurality of impression expression databases comprise:
a first impression expression database comprising a group of options that represent an impression of an entire design of the document; and
a second impression expression database comprising a group of options that represent a partial impression of the design of the document.

4. The recording medium according to claim 2, wherein
the plurality of impression expression databases comprise:
a first impression expression database comprising a group of options that represent an impression of an entire design of the document; and
a second impression expression database comprising a group of options that represent a partial impression of the design of the document.

5. The recording medium according to claim 1, wherein
the plurality of impression expression databases comprise:
a first impression expression database comprising a group of specific options that represent an impression of the design of the document; and
a second impression expression database comprising a group of abstract options that represent an impression of the design of the document.

6. The recording medium according to claim 2, wherein
the plurality of impression expression databases comprise:
a first impression expression database comprising a group of specific options that represent an impression of the design of the document; and
a second impression expression database comprising a group of abstract options that represent an impression of the design of the document.

7. The recording medium according to claim 5, wherein
the group of specific options is adjectives that represent an impression of the design of the document.

8. The recording medium according to claim 6, wherein
the group of specific options is adjectives that represent an impression of the design of the document.

9. The recording medium according to claim 1, wherein
the computer is caused to execute an output processing for dividing a region of an output screen into a plurality of divided screen regions, allocating impression representation for each of the divided screen regions, and displaying the desired impression representation in the divided screen region to which an impression representation matching the desired impression representing is allocated.

10. The recording medium according to claim 2, wherein
the computer is caused to execute output processing for dividing a region of an output screen into a plurality of divided screen regions, allocating impression representation for each of the divided screen regions, and displaying the user impression representation in the divided screen region to which an impression representation matching the user impression representation is allocated.

11. A design creation supporting apparatus comprising:
a memory for storing:
a plurality of impression expression databases including a group of options that represent an impression of a document wherein the group of options are different, and
an impression evaluation database in which impression information got by a person as the person views a document is associated with the options included in the plurality of impression expression databases; and
a controller for:
causing a user to select and acquire at least one option matching an impression that is the target of the design creation of the document from each of the plurality of impression expression databases; and
extracting impression information associated with the option selected from the plurality of impression expression databases by referencing the impression evaluation database and making at least one item of the extracted impression information the desired impression information that represents an impression that is a target of the design creation of the document.

12. A design creation supporting apparatus comprising:
a memory for storing:
a plurality of impression expression databases including a group of options that represent an impression of a document wherein the group of options are different, and
an impression evaluation database in which impression information got by a person as the person views a document is associated with the options included in the plurality of impression expression databases; and
a controllers for:
causing a user to select and acquire at least one option matching an impression that is actually got from the design of the document from each of the plurality of impression expression databases; and
extracting impression information associated with an option selected from the plurality of impression expression databases by referencing the impression evaluation database and making at least one of the extracted impression information the user impression information that represents an impression given by the design of the document.

13. A computer data signal embodied in a carrier wave for enabling a computer having a memory that stores a plurality of impression expression databases, including a group of options that represent an impression of a document wherein the group of options are different, and an impression evaluation database in which impression information got by a person as the person views a document is associated with the options included in the plurality of impression expression databases, to perform a process for supporting design creation, the process comprising:
causing a user to select and acquire at least one option matching an impression that is the target of the design creation of the document from each of the plurality of impression expression databases; and
extracting impression information associated with the option selected from the plurality of impression expression databases by referencing the impression evaluation database and making at least one item of the extracted impression information as the desired impression information that represents an impression that is a target of the design creation of the document.

14. A computer data signal embodied in a carrier wave for enabling a computer having a memory that stores a plurality of impression expression databases including a group of options that represent an impression of a document wherein the group of options are different, and an impression evaluation database in which impression information got by a person as the person views a document is associated with the options included in the plurality of impression expression databases, to perform a process for supporting design creation, the process comprising:
causing a user to select and acquire at least one option matching an impression that is actually got from the design of the document from each of the plurality of impression expression databases; and
extracting impression information associated with an option selected from the plurality of impression expression databases by referencing the impression evaluation database and making at least one of the extracted impression information the user impression information that represents an impression given by the design of the document.
